(19) United States
(12) Patent Application Publication
(10) Pub. No.: US 2022/0197633 A1
(43) Pub. Date: Jun. 23, 2022

(54) SOFTWARE DEFINED BUILD INFRASTRUCTURE FOR HYBRID, VIRTUALIZED AND NATIVE BUILD ENVIRONMENTS

(71) Applicant: Bitrise Inc., Dover, DE (US)

(72) Inventors: Arpad Kun, Hayward, CA (US); Viktor Benei, Budaörs (HU); Barnabas Birmacher, Budaörs (HU)

(21) Appl. No.: 17/557,703

(22) Filed: Dec. 21, 2021

Related U.S. Application Data
(60) Provisional application No. 63/128,587, filed on Dec. 21, 2020.

(51) Int. Cl. G06F 8/71; G06F 9/455

(52) U.S. Cl. CPC G06F 8/71; G06F 2009/45562; G06F 9/45558

(57) ABSTRACT

The present disclosure relates to computer-implemented methods, software, and systems for hybrid virtualization and native application execution through a boot service build infrastructure. A request to execute a build process on source code associated with an application is received at a first server node. The request specifies a build environment associated with executing the build process. In response to receiving the request to execute the build process, a variant of the build environment instantiating at the first server node for building the source code. The variant of the build environment is a bootable image that may include an operating system and software resources for starting the operating system and executing the build process on the source code. A second server node that includes hardware resource for executing the build process can be booted from the bootable image.

### CROSS-REFERENCE TO RELATED APPLICATION

This application claims priority under 35 U.S.C. 119 to Provisional Application No. 63/128,587, filed Dec. 21, 2020, which is incorporated by reference.

### TECHNICAL FIELD

The present disclosure relates to computer-implemented methods, software, and systems for executing build processes in a bootable build infrastructure.

### BACKGROUND

In enterprise software development, a platform landscape can include different software applications and services that are distributed across multiple nodes. When a new version of a software application is released, the complete landscape may need to be evaluated, for example, through execution of the new version over an infrastructure that includes software and hardware resources compatible with the new version. For example, changes submitted to existing source code may be developed, submitted for compilation, built, and executed in a test environment to evaluate performance of the software.

### SUMMARY

The present disclosure features systems, software, and computer implemented methods for hybrid virtualization and native application execution through a boot service build infrastructure.

In a first aspect, one example process can include receiving a request, at a first server node, to execute a build process on source code associated with an application, wherein the request specifies a build environment associated with executing the build process on the source code. In response to receiving the request to execute the build process, a variant of the build environment can be instantiated at the first server node for building the source code. The variant of the build environment can be a bootable image that includes an operating system and software resources for starting the operating system and executing the build process on the source code. The process can include providing, from the first server node, instructions to boot a second server node from the bootable image, wherein the second sever node includes hardware resources for executing the build process on the source code using the variant of the build environment.

In a second aspect, another example process includes receiving a request, at a first server node, to execute a build process on source code associated with an application, wherein the request specifies a build environment associated with executing the build process on the source code. In response to receiving the request to execute the build process, a variant of the build environment can be instantiated at the first node for building the source code, wherein the variant of the build environment is a disk image that includes software resources for executing the build process on the source code. The process can also include providing, from the first server node, instructions to boot a second server node from the disk image, wherein the second sever node includes hardware resources for executing the build process on the source code using the build environment, and wherein the second server node deletes the build environment upon completion of the build process.

In a third aspect, another example process can include receiving, at a second server node from a first server node, instructions to boot a first build environment at the second server node for executing a first build process on source code associated with an application, wherein the second sever node includes hardware resources for executing the first build process. The process also includes obtaining the source code for executing the first build process, and booting the first build environment to execute the first build process. The first build environment is booted based on a first disk image instantiated at the first server node, the first disk image including software resources for executing the first build process. The process further includes executing the first build process within the first build environment, determining that the first build process is complete, and in response, deleting the first build environment such that a subsequent build process is unaffected by build artifacts generated within the first build environment.

Implementations of the above process may include one or more of the following features, or combinations thereof.

In some instances, the request may be received through an application programming interface (API) at the first server node. The request can be managed and scheduled using a control engine included in the first server node. In some instances, the variant of the build environment can be instantiated from one of a plurality of build environments stored in a repository associated with the first server node. In some instances, the first server node can include an application programming interface for receiving and processing requests in relation to execution of build processes over hardware resources provided by server nodes using instantiated variants of build environments at the first server node. In some more instances, the second server node can include a mobile device or a portable computing device. In some instances, the instructions provided to boot the second server node can include instructions for initiating a virtual environment configured to execute multiple build processes in parallel. In some instances, the virtual environment can include a hypervisor that supports a virtual machine for executing the build process corresponding to the source code. In some instances, the virtual environment can be configured to execute multiple build processes on the second server node. In some instances, the instructions provided by the first server node to boot the second server node can include instructions to select the second server node from a pool of server nodes. The second server node can be compatible with the operating system and the software resources for starting the operating system and for executing the build process. In some instances, the process can include include executing one or more tests on a result of the build process. In some instances, in response to booting the second server node from the bootable image, one or more resources for executing the build process can be downloaded. The downloading of the one or more resources can include receiving configuration information identifying resources associated with the build process, the configuration information identifying one or more sources corresponding to the one or more resources. The one or more resources can then be downloaded from the corresponding sources.

In some instances, the first server node includes a connection circuit for connecting the first server node to at least a subset of the pool of server nodes over corresponding hardwired connections. In those instances, the hardwired connections can include one or more universal serial bus (USB) connections. In some more instances, the first server node can be connected to at least a subset of the pool of server nodes over a wired or wireless network.

In some instances, the process includes determining that the build process is complete, and in response, resetting the second server node. When the second server node is reset, the second server node can be made available to receive instructions to boot from a different variant of a build environment instantiated at the first server node. In some cases, resetting the second server node can include deleting one or more software resources generated at the second server node during execution of the build process. In some instances, the built application or updates thereto can be distributed to end-user devices. Quantitative and qualitative metrics can be collected from the end-user devices to evaluate the performance of the application. In some instances, distributing the application to the end-user devices can include storing the application in a repository accessible to the end-user devices.

In some instances, the process can include receiving, at the second server node from the first server node, instructions to boot a second build environment at the second server node for executing a second build process, obtaining source code for executing the second build process, and booting the second build environment to execute the second build process. The second build environment can be booted based on a second disk image instantiated at the first server node, the second disk image including software resources for executing the second build process. The second build process can be executed within the second build environment. A determination may be made that the second build process is complete; and in response, the second build environment can be deleted such that a subsequent build process to the second build process is unaffected by build artifacts generated within the second build environment.

In a fourth aspect, an example system can include components including: a plurality of ports, wherein each port is configured to connect to a corresponding node that includes a build environment for executing a build process on a source code associated with an application. The system can include a plurality of device-mode-capable controllers, each device-mode-capable controller being connected to a corresponding port of the plurality of ports, and a switch configured to connect the plurality of device-mode-capable controllers to a motherboard of a computing device that boots from one or more of nodes connected to the plurality of ports and provides hardware resources to execute build processes on corresponding source codes.

In some instances, at least one port of the plurality of ports is a universal serial bus (USB) port. In those instances, optionally, each of the plurality of ports connects a corresponding one of the plurality of device-mode-capable controllers to a corresponding node. In some instances, at least one corresponding device-mode-capable controller connects to the at least one port is a USB controller. In some instances, a first node of the one or more nodes connects through a first controller of the plurality of device-mode-capable controllers to the motherboard of the computing device to provide instructions to boot and execute a first build process using a first build environment. In some instances, a second node of the one or more nodes connects through a second controller of the plurality of device-mode-capable controllers to the motherboard of the computing device to execute a second build process using a second build environment different from the first build environment. At least a portion of the first build process may execute in parallel to the second build process. In some instances, the build environment can be a bootable image that includes an operating system and software resources for starting the operating system and for executing the build process on the source code.

In a fifth aspect, the process as discussed above in the first aspect and related optional features can be executed on a first server node that optionally includes a connection circuit for connecting the first server node to at least a subset of the pool of server nodes over corresponding hardwired connections. The connection circuit can be substantially similar to as discussed above in relation to the fourth aspect.

Other implementations of these aspects include corresponding systems, apparatus, and computer programs, configured to perform the actions of the methods, encoded on computer storage devices. For example, a system can include one or more processing devices and a computer-readable non-transitory storage device coupled to the one or more processing devices, the storage device having instructions stored thereon which, when executed by the one or more processing devices, cause the one or more processing devices to perform any of the processes described herein.

Similar operations and processes may be performed in a system comprising at least one processor and a memory communicatively coupled to the at least one processor where the memory stores instructions that when executed cause the at least one processor to perform the operations. Further, a non-transitory computer-readable medium storing instructions which, when executed, cause at least one processor to perform the operations associated with any of the processes described above are also contemplated. In other words, while generally described as computer implemented software embodied on tangible, non-transitory media that processes and transforms the respective data, some or all of the aspects may be computer implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description, drawings, and from the claims.

### DESCRIPTION OF DRAWINGS

FIG. 1 illustrates an example environment for deploying the technology described in the present disclosure.

FIG. 2 is a block diagram of an example system for booting a server node from a bootable image instantiated at boot service server in accordance with implementations of the present disclosure.

FIG. 3 is a flowchart of an example process for booting a server node in accordance with implementations of the present disclosure.

FIG. 4 is a flow chart of an example method for booting a server node, executing a build process, and performing testing in accordance with implementations of the present disclosure.

FIG. 5 is a block diagram of an example system for booting a server node from a bootable image instantiated at service server that connects with the server node through a hardwired connection circuit or a wireless network connection, in accordance with implementations of the present disclosure.

FIG. 6 is a block diagram of an example system for building, testing, and distributing an application to end-user devices in accordance with implementations of the present disclosure.

FIG. 7 is a block diagram of a connection circuit usable for implementing the technology described in the present disclosure.

FIG. 8A is a block diagram of an example system for executing a build request in a virtual build environment in accordance with implementations of the present disclosure.

FIG. 8B is a block diagram showing additional details of the system of FIG. 8A.

FIG. 9 is a block diagram of an example system 1000 for building and testing an application in parallel on multiple server nodes in accordance with implementations of the present disclosure.

FIG. 10 is a schematic illustration of example computer systems that can be used in implementing the technology described in the present disclosure.

### DETAILED DESCRIPTION

The present disclosure describes various tools and techniques for implementing an efficient software-build infrastructure that facilitates, among other applications, flexible, fast and high-quality software development for continuous integration and development (CI/CD) pipelines. Specifically, the technology described herein speeds up the process of compiling, building, testing and delivering software products (e.g., applications) to end-users and getting actionable feedback from the end-users to improve the quality and reliability of the software products. This is facilitated, for example, by maintaining a repository of various build-resources in the form of disk images (referred to herein as bootable images) and booting hardware devices (e.g., a server, personal computing device, etc.) from such disk images to generate build environments for performing software build processes. In some implementations, the disk images include various software resources such as compilers, simulators, etc., together with an operating system. Such disk images are referred to herein as bootable images. In some implementations, the disk images include the various software resources but not an operating system. Such disk images are referred to herein as container images, which rely on the operating system of a device (e.g., a server) or a hypervisor to boot up a build environment. Because a bootable image or container image includes the required build resources for instantiating a build environment, multiple build environments can be executed on a server or other computing device in parallel, and/or independently of one another. Consequently, a particular build environment can simply be deleted at the end of a build process and replaced with a newly instantiated clean build environment for a new build process. Such efficient and potentially parallel use of self-sufficient build environments that may be running different operating systems (e.g., when booted from bootable images) can increase throughput and speed up the overall process of building, testing, and delivering software applications to end-users, and thereby significantly improve the user-experience for software developers.

Development of a software product can include multiple stages, including, for example, developing, compiling, building, testing and delivering the software product to end users. Based on feedback received from the end-users, upgrades and updates can be developed, resulting in release of newer versions. Incremental improvements to software products are often facilitated via a continuous integration (CI) and continuous delivery (CD) pipeline. CI/CD can be defined as set of operating principles and practices that enable software developers to deliver changes to source codes (e.g., to implement an improvement) frequently and reliably. Specifically, CI allows software developers to implement small changes to source codes and validate such changes to version control repositories frequently. The overall goal of CI is to establish a consistent and automated way to build and test source codes underlying applications. CD, on the other hand, automates delivery of code changes to various infrastructure environments, such as development and testing environments. In some cases, a CI/CD pipeline can include continuous testing to ensure delivery of high-quality applications to end-users.

Software developers use various programming languages, tools, testing tools, emulators, etc. in a CI/CD pipeline. As the tools evolve over time, and new versions emerge, testing across different releases can become cumbersome. A compile/build environment set up with a particular set of resources may not be suitable for building applications that require a different set of resources. For example, a particular Xcode® version installed on MacOS® to compile iOS® applications may not be suitable for executing build processes on applications for earlier versions of iOS®. In another example, if an application is written using an earlier version of Swift °, the application may not be built/compiled using a version of Xcode® that is relatively newer as compared to the version compatible with the earlier version of Swift °. One way to address such incompatibility between applications and corresponding build requirements is to maintain multiple computing devices each having a different build environment that includes a particular operating system and a particular set of build resources. Another possibility is to maintain different build environments as different virtual machines that may be provided to a remote computing device to execute a build process. However, these solutions may not allow a particular computing device to execute multiple build environments in parallel, thereby slowing the overall build process. In addition, a particular build process may install a software component that is incompatible with, or otherwise affects, a subsequent build process—which in turn may require an uninstall/update that reduces overall throughput. Notably, in various instances, it may be beneficial to initiate a build process in a clean, known environment such that the build process is repeatable and idempotent.

The technology described in this document facilitates booting of native or virtual build environments at a particular computing device from an appropriate bootable image via a virtual port of the computing device. In some instances, by booting via a virtual port of the computing device, the bootable image can be accessed from the computing device as if it is connected through a hardware port. Because all build resources, as well as the operating system are provided on the bootable image, build artifacts are avoided on the computing device itself, and a particular environment can be completely deleted upon completion of the build process. This allows for efficient and clean switches between one build environment and a subsequent one, thereby facilitating a high-throughput process. In addition, if unused hardware is available on a computing device, multiple build environments may be executed in parallel to increase throughput.

In some implementations, the technology described herein can enable developers to dynamically choose from running a build process (i) in a virtualized environment where multiple virtual machines can run in parallel (virtualized build environment), or (ii) natively on a single bare metal computer, having access to hardware resources such as GPU, memory, etc. (native build environment). In a virtualized build environment, the multiple virtual machines can run in parallel on one computing device, for example, using a hypervisor or containers and build/test code runs in virtually separated environments. In a native build environment, integrity of the environment is maintained across builds, such that two subsequent builds do not affect each other. This flexible approach allows for getting the benefit of a virtualized build environment—where a build process starts from a predefined “clean” state of the environment every time, and builds don't affect each other—while reducing or even removing performance penalties typically associated with such virtualization.

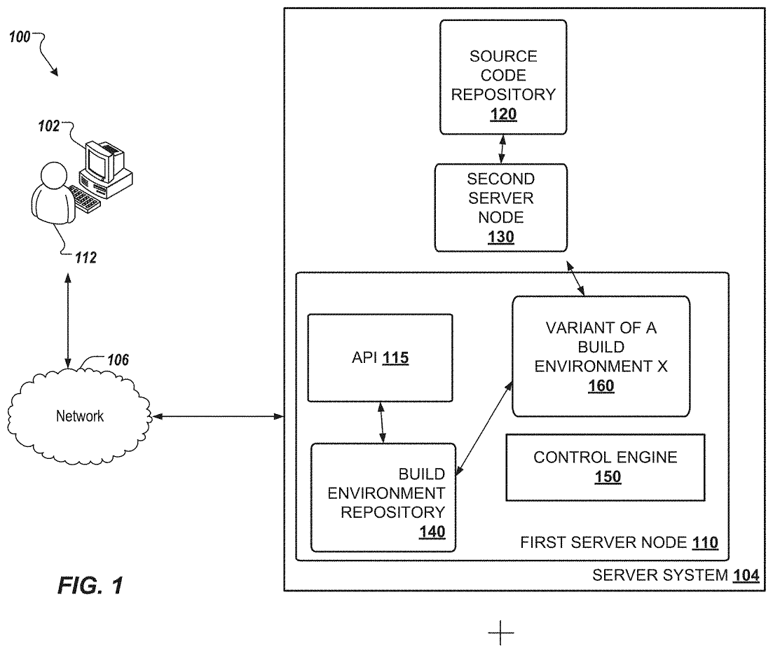

FIG. 1 depicts an example environment 100 for deploying the technology described in the present disclosure. The environment 100 includes a client device 102, a network 106, and a server system 104. A user 112 (e.g., a software developer) may interact with the server system 104 using the client device 102. The server system 104 can include one or more server nodes that communicate with one another over hardwired or wireless networks to implement the technology described herein. For example, the server system 104 can include a first server node 110 that has access to a build environment repository 140 storing the various bootable images underlying different build environments used in potential build processes.

The first server node 110 receives requests for initiating a build process at an application programming interface (API) 115 and processes the requests using a control engine 150. For example, the control engine 150 can be configured to evaluate requirements associated with a received build request, and perform operations to execute the requested build process in accordance with technology described herein. In some instances, the control engine 150 may receive requests for execution of a build process for a software application, or a particular version of that software application. The control engine 150 may implement logic to schedule tasks in relation to received requests and to manage load distribution at the first server node 110. In some instances, the control engine 150 can be configured to monitor and/or manage resources, and schedule workload. While the example of FIG. 1 shows the API 115 as a part of the first server node 110, the API 115 can reside on another computing device within the server system 104. In some implementations, the API 115 can be implemented as a part of the control engine 150.

In some instances, the first server node 110 may provide a booting service to instantiate a variant of a build environment as a bootable image that can be used to boot another server node, such as second server node 130. The particular build environment needed for a build process can be identified, for example, by the control engine 150 by processing the build request received via the API 115. For example, the particular build environment can be determined as one that is compatible with the requirements of the build process for the software application. This can include, for example, determining what version of operating system (e.g., what version of iOS®) and/or other software resources (e.g., what version of XCode®) is needed to build the particular source code identified in the received request, and identifying an appropriate image of build environment stored in the build environment repository 140. In some cases, the build environment can be determined based on evaluation of a plurality of template build environments stored in the build environment repository 140. In some instances, the build environment repository 140 may be maintained within the first server node 110, where in other instances, the build environment repository 140 may be hosted separately and invoked through remote requests sent by the first server node 110.

In some implementations, an identified build environment, such as build environment X, can be retrieved from the build environment repository 140 and cloned to instantiate a variant of the build environment 160 at the first server node 110. This variant of the build environment X 160 can be used to boot the second server node 130 for executing the build process. The variant of the build environment X 160 can be instantiated as a bootable image including an operating system and software resources for starting the operating system and for executing the build process on the source code. In some instances, a build environment (and correspondingly, the cloned variant of the build environment) can be provided as a disk image that includes an operating system and other software resources necessary for booting the operating system to build and test source code associated with a software application. The hardware resources for executing a build process is provided, at least in part, by the server node (e.g., the second server node 130 in the example of FIG. 1) on which a build environment is booted up from the corresponding variant 160 of the build environment. In some implementations, the execution of the build and test processes may be dependent on access to external resources such as source codes, libraries, images, metadata, configuration files, etc. Such external resources may be downloaded after a build environment is booted up.

The booted server node (the second server node 130, in the example of FIG. 1) provides at least a portion of the hardware resources for executing a build environment to build and test a software application. The server node 130 is booted from a variant of a build environment 160 instantiated at the first server node 110 such that the build process runs natively or in a virtualized manner on the hardware of the second server node 130 within a corresponding software build environment. In some implementations, the server node 130 may be configured to run multiple build environments as virtual machines or containers in parallel via a hypervisor. In some implementations one or more virtual machines can be configured to run nested within another virtual machine. In some implementations, the build environments can be run as containers, each of which is a software package that is configured to execute independently on bare metal or a virtual machine using the operating system associated with the bare metal or the virtual machine, respectively. In some implementations of a virtualized environment, multiple containers multiple containers can be run nested within another container. In some implementations, the server node 130 may run the build process natively on a single build environment that can be reset/deleted upon completion of the build process, and a new build environment that is unaffected by the previous build environment can be booted on the server node 130. In some instances, multiple server nodes can be booted from instantiated variants of build environments. Notably, while the example in FIG. 1 shows a single second server node 130, in some implementations, the second server node 130 may be one of multiple server nodes that are available to be booted from the first server node 110 (or another server node, in general) using a variant of a corresponding build environment.

In some instances, the technology described herein may allow software developers to dynamically choose whether to perform a build process in a virtualized environment or to run the build process on an operating system running natively on a server node or computing device. When the build process runs in a virtualized environment, multiple virtual machines can run in parallel on the same hardware machine using a hypervisor or containers, and parallel building and testing operations can be executed in virtually separated environments. When the build process runs natively on a server or computing device, or on parallel virtual machines or containers over a hypervisor, integrity of the environment between different build processes can be ensured, so that two subsequent build processes are independent of each other and do not affect each other. In some instances, such independence and isolation of build processes can be ensured by resetting the server node and/or deleting the build environment booted for a particular build process upon completion of the particular build process.

In some instances, source code can be stored in a source code repository 120. Source code developed in a given computer programming language can be converted to an application program in an executable or binary file format. The process of creating such an application program from a source code is referred to herein as a build process. In some implementations, a build process can include fetching the source code from a source code repository, and compiling the code to create/obtain components that may be collectively referred to as build artifacts. In some instances, the source code may be retrieved from the source code repository 120 into an instantiated build environment at the second server node 130. While the source code repository 120 is depicted as a part of the server system 104, in some implementations, the repository 120 may reside outside the server system 104. The build artifacts can be tested, for example, according to one or more test criteria.

In some instances, the source code repository 120 (or access to the source code repository) may be provided by a customer and may be accessible from nodes at the server pool 240. The source code repository 120 may provide access to the stored source code based on access credentials for source code to be downloaded at a server node of the server pool 240. In some instances, the customer provides a uniform resource locator (URL) for the source code repository 120 (and/or credentials to access the source code repository), and the boot service server 215 automatically downloads a corresponding source code to scan the source code. This can be done, for example, to scan for known configuration files within the code to determine a recommended build environment for the code.

In some instances, when a request to execute a build process for a particular software application is received at the boot service server 215, the source code associated with the particular software application can be downloaded from the source code repository 120 and scanned for configuration files within the code to determine a recommended build environment for the source code. In some cases, the boot service server may recommend multiple build environment versions for a given source code such that a user may select one of the recommended build environments for the build process. In some implementations, the boot service server 215 can be configured to recommend a build environment based on predefined criteria defining a default build environment for source code developed with a particular technology and/or programming language. In some instances, one or more build environments may be determined as relevant and/or applicable to a particular build process, and a user interface of the boot service server 215 may provide those one or more build environments as selectable options for an end-user when requesting execution of the build process.

In some instances, the downloaded source code can be scanned to determine a corresponding project type. The project type may be associated with a corresponding technology platform. For example, the source code can be scanned and then classified as corresponding to one of: an iOS® project, a macOS® project, an Android™ project, a Xamarin® project, a Fastlane® project, a Cordova™ project, or another type of technology project. Determining the project type can be based on, for example, detecting a particular file type and/or configuration in the source code. For example, based on detecting a CocoaPods manager and/or valid Xcode® command line configurations in a source code, a determination can be made that the source code is associated with an iOS® project and/or a macOS® project. As another example, to determine that the source code is associated with an Android project, the source code can be checked for whether the code includes build.gradle files, lists of gradle tasks, and/or a gradlew file. As yet another example, to determine that the source code is associated with a Xamarin® project, the source code can be checked for whether the source code includes solution files and lists of configuration options, and optionally whether the source code includes NuGet™ and Xamarin® Components packages. As yet another example, for determining that the source code is associated with a Cordova project, the source code can be scanned to determine whether the source code includes a config.xml file. In another example, to determine that the source code is associated with Fastlane, the source code can be scanned to detect a Fastfile® and lists of available lanes.

In some instances, if a build environment cannot be determined from scanning the source code, a list available build environments can be provided, for example, via a user interface of the boot service server, for manual selection by an end user initiating the build process.

In some instances, after a build environment is selected by the end-user from a list of recommended environments for a particular source code, or from a list of all available build environments, the selected build environment may be stored as a default setting for builds that are to be run in relation to the corresponding software application. In some cases, the stored default settings can be updated at any time to specify a different build environment per build, for example, to provide a different build environment when requesting a build with a specific environment, other than the default one. In some instances, a build process can include compiling the human-readable source code into machine-readable form. The build process may also include determination of dependencies and checking for consistency between various software components or modules of associated with the source code. The compiled source code (e.g., object code) can be linked with libraries, additional code, files, etc. to build executable files that can be run on different devices, such as servers, portable devices, mobile devices and other devices. In some implementations, the build process may include generating an executable file.

In some implementations, one or more tests may be performed on the compiled and/or executable files. Testing can be performed as part of the build process or in addition to the build process. In some cases, the test criteria can be defined and implemented through executable tests, or test scripts that can be run on the results of the build process or as a part of the build process. If the tests are successful, the generated executable files and/or other artifacts of the build process can be delivered for installation and execution by end-user devices. In some instances, when new components are built, build artifacts can be published in release repositories created for delivery of build artifacts to end-user devices. The build artifacts can be published, for example, using standard tools or platforms for managing application delivery. For example, different binary management systems may be used for maintaining instances of repositories for storing binary artifacts. Further, different technologies for build management of software artifacts can be used in relation to a given software product release, such as MAVEN, NPM, and DOCKER. Speed and efficiency of software delivery, including, for example, delivery of updates, patches, fixes, new features, add-ons, etc. can be associated with the speed of executing build and test processes. Thus, faster release cycles and release of products to end-users can be achieved through providing an infrastructure to facilitate build and test process execution in an efficient manner with improved resource spending.

In some implementations, the client device 102 includes one or more computing devices such as a desktop computer, a laptop computer, a handheld computer, a tablet computer, or another data processing device that can be used for software development. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems. In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, the server system 104 can be configured to accept software build requests from and provide corresponding build services to multiple client devices 102.

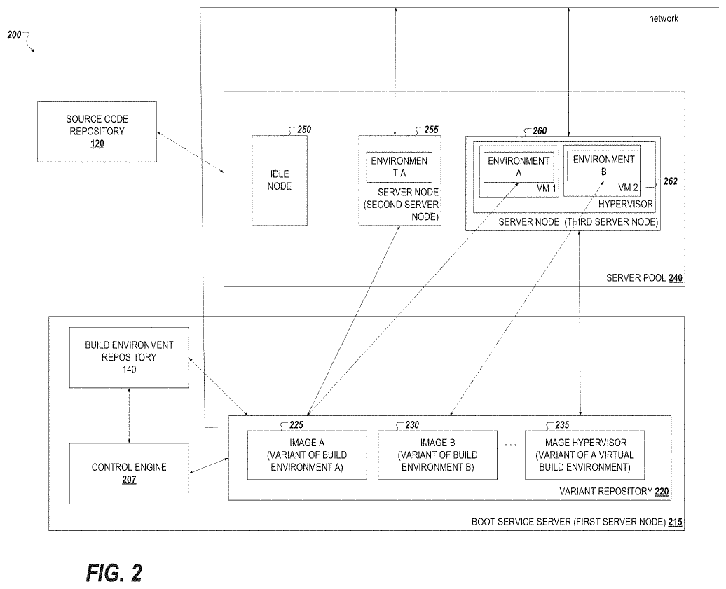

FIG. 2 is a block diagram for an example system 200 for booting a server node from a bootable image instantiated at a boot service server 215 in accordance with implementations of the present disclosure. In some instances, the boot service server 215 can be substantially identical to the first server node 110 of FIG. 1. In some instances, the example system 200 may be set up for executing build processes on multiple server nodes 250, 255, 260 in a server pool 240, wherein the server nodes are booted from variants of corresponding build environment images 225, 230, 235 instantiated at the boot service server 215.

In some instances, a user (e.g., a software developer) may request execution of a build process via an API of a control engine 207. In some implementations, the API can be substantially identical to the API 115 described with reference to FIG. 1. The user may request the build process for a software application associated with source code stored at a source code repository 120. In some implementations, the API can be configured to accept, from the user as a part of the build request, the source code underlying the build process. The control engine 207 may include back-end logic for processing build requests and scheduling build tasks from the boot service server 215. In some implementations, the control engine 207 is substantially identical, structurally and/or functionally, to the control engine 150 of FIG. 1.

A request for executing a build process can be received at the boot service server 215, and the request can be evaluated to determine a server node that can be booted for executing the build process. For example, the server node can be selected from the server pool 240 that includes multiple server nodes. Some of the server nodes in the server pool 240 can be in an idle mode, i.e., available to be booted to execute a build process, while some of the server nodes in the server pool can be in an operational mode, i.e., currently booted from an instantiated build environment image at the boot service server 215 and/or executing one or more build processes. In the example of FIG. 2, the idle node 250 is a server node that is in the idle mode, and the second server node 255 is in an operational mode running a build environment A as booted from an instantiated build environment image A 225.

In some instances, the server pool 240 can include a server node 260 that is booted as a virtual environment configured to execute multiple build processes in parallel. The virtual environment can be generated by booting the node 260 from a hypervisor image 235 instantiated at the boot service server 215. This results in the server node 260 executing a hypervisor 262 that supports one or more virtual machines VM1, VM2, etc., for executing one or more build processes. Each of these virtual machines can be booted from corresponding bootable images instantiated at the boot service server to execute respective build environments.

In some instances, the server node 260 can have a hypervisor image installed manually to the local disk drive of the server node 260, and not booted remotely from the first service server. In such instances, the server node 260 may support an execution of multiple virtualized environments by starting virtual or containerized build environments on corresponding virtual machines running within the hypervisor.

In the example of FIG. 2, VM1 runs build environment A booted from the image 225 and VM2 runs build environment B booted from image 230. In some implementations, the hypervisor 262 and/or the environments within the virtual machines can be booted from corresponding bootable images in the boot service server in response to build requests received at the boot service server. The source codes corresponding to the build requests can be retrieved, for example, from the source code repository 120. The server pool 240, including the booted server nodes running build environments, may be communicatively coupled to the source code repository 120 to download source codes. The server pool may also be communicatively coupled to one or more additional sources (e.g., external or internal databases) to obtain other resources as needed for executing the build processes.

The boot service server 215 can be configured to boot the server nodes at the server pool 240 in various ways. For example, a server node in the server pool can be booted via an USB boot (in which the bootable image is provided to the corresponding server node in the server pool 240 via an USB connection), a network boot (in which the bootable image is provided to the corresponding server node in the server pool 240 over a wired or wireless network), or a network adapter boot (in which the bootable image is provided to the corresponding server node in the server pool 240 via network adaptor circuit). The control engine 207 of the boot service server 215 may be configured to select server nodes from the server pool 240, and boot the selected server nodes from bootable images to either run build environments natively or in a virtualized fashion (e.g., by running a hypervisor configured to support multiple build environments in virtual machines, by running an environment that runs builds in parallel in containers on the same server node).

In some instances, the boot service server 215 instantiates variants of build environments as bootable images in response to different build requests. The bootable images can be instantiated, for example, from a copy of a corresponding image maintained at the build environment repository 140. In some instances, the build environment repository 140 may be maintained at the boot service server 215 or may be external to the boot service server 215. The build environments stored at the build environment repository 140 can represent combinations of various versions and types of operating systems and corresponding compatible software resources for starting the operating systems and executing build processes. For example, a first build environment may include an operating system X, a compiler Y, a build engine K, and a simulator Z, which are compatible with executing build processes on server nodes of type T. The particular build environment corresponding to a build request can be selected based on information included in the build request.

In some instances, the boot service server 215 may instantiate one or more bootable images based on images of environments stored at the repository 140 in response to a received build request. For example, the control engine 207 may identify whether there exists an image of a build environment that includes an operating system and software resources compatible with the received request, and instantiate a copy of such an image as the bootable image corresponding to the request. In some implementations, the control engine 207 may identify an already-instantiated variant (or bootable image) available in the variant repository 220 for servicing the request. In some implementations, the control engine 207 can be configured to identify an unutilized server node, such as an idle node 250, to boot a build environment for servicing the request. The boot service server 215 may boot server nodes in the server pool 240 directly from instantiated bootable images available at the variant repository 220.

In some instances and in accordance with implementations of the present disclosure, the boot service server 215 can be configured to provide native and virtualized build environments. This can be done on-demand and/or predictively before a build-request is received at the control engine 207. In some implementations, in a predictive mode of operation, a probability of receiving a particular type of build-request (and consequently, the corresponding build environment) can be estimated, for example, using a predictive model based on past requests from a particular developer, and corresponding bootable images can be instantiated accordingly. This can improve response time of the boot service server 215 by predictively provisioning bootable images for various build environments at the repository 220, and potentially further improving the throughput of the system. In some implementations, the boot service server 215 may use historical data to train machine learning models to estimate what bootable images can be pre-generated at the variant repository 220. For example, the training may be performed based on criteria such as frequency of requested images and type of images on a weekly basis, per day, per specific day of the week, hourly, etc. Other historic data that may be used to train a model to support predictions of requests can include, for example, available disk storage space at the boot service server, time-of-day, customer or account data, or geo-location. In some implementations, the control engine 150 can include a task scheduler that generates instructions for instantiating various bootable images at the variant repository 220 based on outputs from a predictive model.

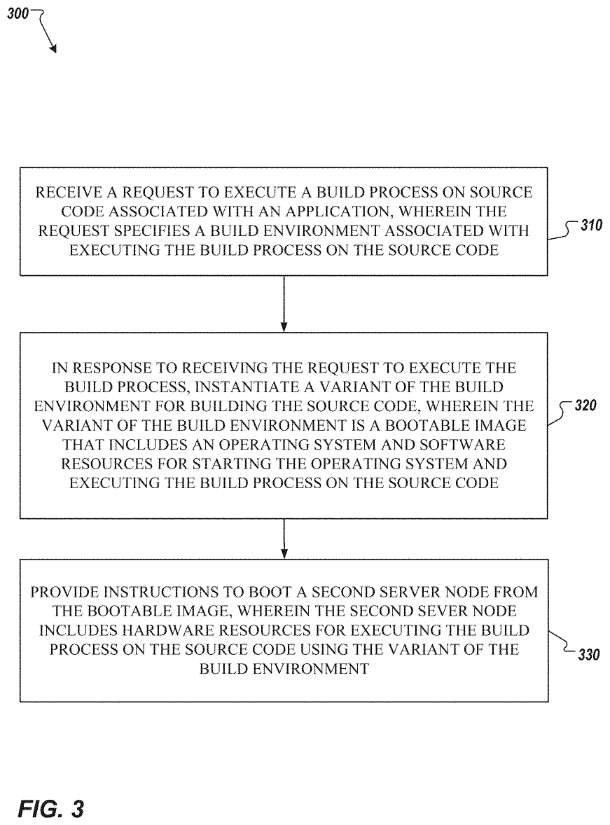

FIG. 3 is a flowchart for an example method 300 for booting a server node in accordance with implementations of the present disclosure. In some instances, the example method 300 can be executed at a server node, such as the first server node 110 of FIG. 1, or the boot service server node 215 of FIG. 2.

At 310, a request is received, where the request is to execute a build process on source code associated with an application. The request can specify a build environment associated with executing the build process on the source code. In some instances the build environment can include software resources and an operating system that can be run on a server to execute a build process on a source code. The source code can be obtained from a source code repository, such as the source code repository 120 of FIG. 1. The source code of the application can be generated based on different programming languages and paradigm and may be associated with different development environment requirements and compatibility constraints for the underlying hardware and software resources. For example, programming languages may be associated with different programming paradigms, such as concurrent computing, declarative programming, functional programming, object-oriented programming, etc. Different programming languages may be associated with technology platforms and tools for developing and executing source code.

In some instances, the request is received at the first service node through an application programming interface (API). The first server node may include the API for receiving and processing requests in relation to execution of build processes over hardware resources provided by server nodes using instantiated variants of build environments at the first server node. In some instances, the request can be managed and scheduled using a control engine, such as the control engine 150 of FIG. 1 or the control engine 207 of FIG. 2.

At 320, in response to receiving the request to execute the build process, a variant of the build environment (e.g., the variant 160 of FIG. 1) is instantiated for building the source code. The variant of the build environment can be a bootable image that includes an operating system and software resources for starting the operating system and executing the build process on the source code. In some instances, the variant of the build environment is instantiated based on a predefined image that can be defined as a template image for a corresponding combination of a version of an operating system, and other software resources such as a compiler, a simulator, and/or other software tools. In some instances, the variant of the build environment is instantiated from one of a plurality of build environments stored in a repository such as the build environment repository 140 associated with the first server node.

At 330, instructions to boot a second server node from the bootable image are provided by the first server node. The second sever node includes hardware resources for executing the build process on the source code using the variant of the build environment. In some instances, the second server node comprises a mobile device or a portable computing device. For example, the second server node can be a portable computing device that is compatible with a set of operating systems (including a set of versions of one operating system type) and a set of development environments and technologies for developing, building, testing, and managing source code. In some implementations, the second server node can be booted substantially in one of the ways described above with reference to FIGS. 1 and 2.

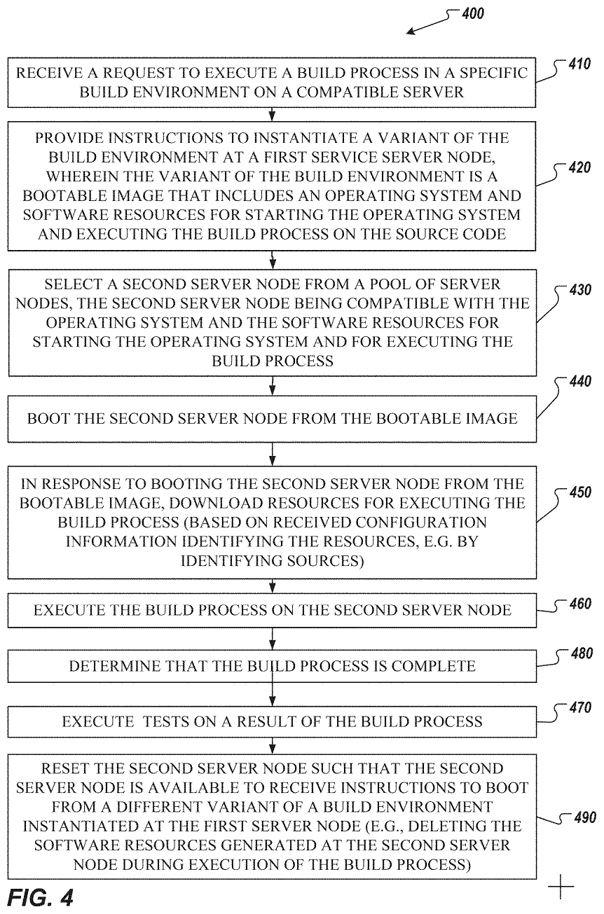

FIG. 4 is a flow chart for an example method 400 for booting a server node(s), executing a build process and performing testing in accordance with implementations of the present disclosure. In some instances, the example method 400 can be executed at a server node, such as the first server node 110 of FIG. 1, or the boot service server node 215 of FIG. 2, and in relation to a second server node such as the second server node 130 of FIG. 1 (or server nodes 255, 260 of FIG. 2).

At 410, a request to execute a build process is received. The request may be received at a control engine interface that can be external or internal to a server. The server may instantiate and manage variants of build environments that are cloned based on build environment defined as templates or preconfigured build environment set-ups that can be instantiated at the server. The instantiated variants can be used to remotely boot another server node over wireless or wired connection. The request may be for a specific build environment to be booted on a compatible server.

At 420, instructions can be sent to a service server node to instantiate a variant of the build environment for building the source code. In some implementations, the variant of the build environment can be a bootable image that includes an operating system and software resources for starting the operating system and executing the build process on the source code. In some implementations, the variant of the build environment can be a container image that includes software resources for supporting a build process but not the operating system. In some instances, the variant of the build environment is instantiated based on a predefined image that can be defined as a template environment that includes software components for executing a build process. In some instances, the software component may include a compiler of a certain type and version, a simulator, or other development or build tools or components. In some more instances, the variant of the build environment may include a container image that can run in virtualized mode on a server node and host the execution of a build process.

At 430, a second server node is selected. The second server node can be selected from a pool of server nodes, such as the server pool 240 of FIG. 2. The pool of server nodes may include a plurality of machines having different hardware characteristics and compatibility with different software systems and applications, thus, corresponding to various of build environments compatible with different operating systems and software resources.

At 440, the second server node is booted from the bootable image that is instantiated at the first server node based on the instructions sent at 420. The second server node can be booted based on instructions from the first server node (that may represent a boot service server configured to start or boot servers from instantiated build environments such as bootable images or container images). In some instances, while the bootable image is used for booting the second server node, the bootable image is maintained at the first server node. For example, a hypervisor running on the second server node, or the second server node itself, may remotely boot one or more build environments via a network mount where all read/write operations associated with the boot are performed over a network. In some more instances, a bootable image corresponding to a build environment can be downloaded—in some cases, temporarily—from the first server node to a hypervisor running on the second server node, such that the corresponding build environment may be booted within the hypervisor.

In some instances, the second server node can be booted from a bootable image for a virtualized environment where multiple build environments may run on virtual machines within the virtualized environment. For example, the virtualized environment can be a hypervisor (booted on the second server node from an appropriate bootable image in the first server node) that supports multiple virtual machines and/or containers to run in parallel. The build environments in the virtual machines and/or containers can in turn be booted from corresponding disk images at the first server node. In some instances, a build process can be executed in a virtualized environment, for example by using a virtual machine and/or a container. A single server node can be booted from a hypervisor image wherein multiple virtual machines can be started within the hypervisor for execution of multiple build processes in parallel. Once a build is executed within a virtualized environment on a server node, and after the build execution is completed, the server node can be restored to a clean state to discard the changes that may have happened within the virtualized environment during the build process.

In some instances, an operating system of a server node can support execution of one or more containers to execute corresponding build processes in parallel. In some instances, the one or more containers may run on the server node natively or on virtual machines instantiated on the server node. In some cases, an OS can have a capability to run containers (natively or in virtualized mode) in parallel to execute independent builds that do not affect one another. When a build process is completed, changes within the particular individual virtualized environment can be discarded without affecting the other virtualized environments running on other containers. For example, while a LINUX OS can run containers natively, the kernel of another operating system may not be configured to run containers natively. For such operating systems, to run build processes in a containerized mode, the operating system can be configured to run one or more virtual machines, which in turn run LINUX OS and run containers within the LINUX OS.

In some instances, instead of discarding a build environment right after execution of a build process, the build environment may be used to support execution of additional tasks. In some implementations, such tasks may be post-build tasks that may run on the same build environment without being affected by the build artifacts from the concluded build process. For example, such tasks may be repetitive tasks that can be performed within the running build environment without the need to restore the server node to its original idle mode. In some instances, such tasks may be executed within nested virtualized environments (virtual machines or containers) booted within the build environment. Such tasks can include, for example, tasks outside of, but related to the build process, such as debugging operations or testing operations, for example, on a specific part of the build that does not affect the rest of the components of the software application.

At 450, in response to booting the second server node from the bootable image, resources for executing the requested build process are downloaded. The downloading of the resources can include receiving configuration information for the build process, the configuration information identifying the resources that are to be downloaded. In some instances, the resources may be identified by resource locators (e.g., URLs) for locating them. In such case, the resource may be downloaded from the identified location.

At 460, the build process is executed on the second server node. The build process can be configured to correspond to the technology and format of the source code of the application associated with the build process. At 470, it is determined that the build process is completed.

At 480, tests are executed on a result of the build process. For example, tests can be executed on the software application generated as a build artifact by the second server node as a result of the build process. In some more instances, tests can also be executed as a part of the build process itself, and portions of the build process may be addressed accordingly.

At 490, the second server node is reset. When the second server node is reset, the second server node may become available to receive instructions to boot from a different variant of a build environment instantiated at the first server node. For example, the second server node may take an idle state in a pool of server nodes associated with the first server node and the boot service. In some instances, resetting the second server node comprises deleting one or more software resources generated at the second server node during execution of the build process. In some instances, instead of resetting the second server node at 490, the second server node can be returned to an idle state or maintained in a waiting mode for subsequent tasks within, or related to, the particular build, for example, as defined during the booting at 440. In those instances where the second server node waits for subsequent tasks, the build environment is not rebooted or deleted. In some instances, when the build process is finished, the first server node may “unplug” the bootable image from the second server node, and then the second server node can be restored to a state corresponding to the state of the second server node before the booting operation at 440 had been performed.

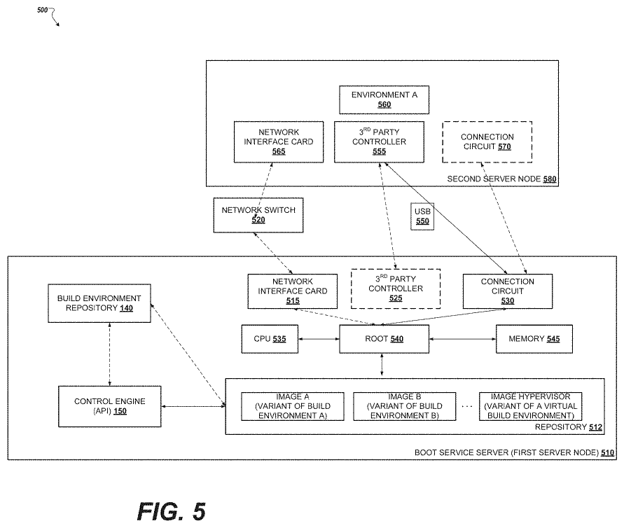

FIG. 5 is a block diagram for an example system 500 for booting a server node 580 from a bootable image instantiated at boot service server 510 that connects with the server node 580 through a hardwired connection circuit or a wireless network connection in accordance with implementations of the present disclosure. In some implementations, the boot service server 510 is substantially identical to the first server node 110 of FIG. 1.

In some instances, the server node 580 is booted from the boot service server 510, and not from corresponding local drives. For example, the second server node 580 may be turned on and off remotely and booted from a bootable image from the repository 512. The second server node 580 can be configured to boot remotely from a bootable image or a container image at the repository 512 over a wired or wireless connection, for example, a USB connection, a network boot connection, a Mellanox® SNAP (RDMA, RoCE) connection, or a connection according to another protocol enabling booting from a remote location such as the boot service server 510. In some instances, the repository 512 at the boot service server 510 may be connected to one or more server nodes, such as the second server node 580, through a communication established through a root 540 at the boot service server 510. The root 540 may implement logic to define the connection between the repository 512 and a server node and to instruct the server node to boot from an image at the repository 512. The root 540 may be communicatively coupled to a memory 545 and CPU 535 at the boot service server 510.

The boot service server 510 and the second server node 580 can be connected in various ways. For example, the communications between the boot service server 510 and the second server node 580 can be based on connections between network cards or controllers that control communication channels over a local area network, or over a USB connection. In some instances the boot service server 510 and the second server node 580 may each include at least one of a network interface card 565, 3^{rd} party controller 555, and/or a connection circuit 570, that can be used to establish a communication channel between the boot service server 510 and the second server node 580. In some implementations, a physical network card on the boot service server 510 can facilitate the connection between the boot service server 510 and the second sever node 580. For example, the boot service server includes a network interface card 515 that can connect over a network switch 520 to the network interface card 565 of the second server node 580. Such a network card can be proprietary to the boot service provider or a third party. The connection between the second server node 580 and the boot service server 510 can be established so that the second server node 580 boots directly from a bootable image (or a container image) from the repository 512 on the boot service server 510. In some implementations, the boot service server 510 includes a control engine 150 and a build environment repository 140 as described above with reference to FIG. 1. In some instances, the second server node 580 may be booted from “Image A” at the repository 512 to start the “Environment A” 560 on the second server node 580.

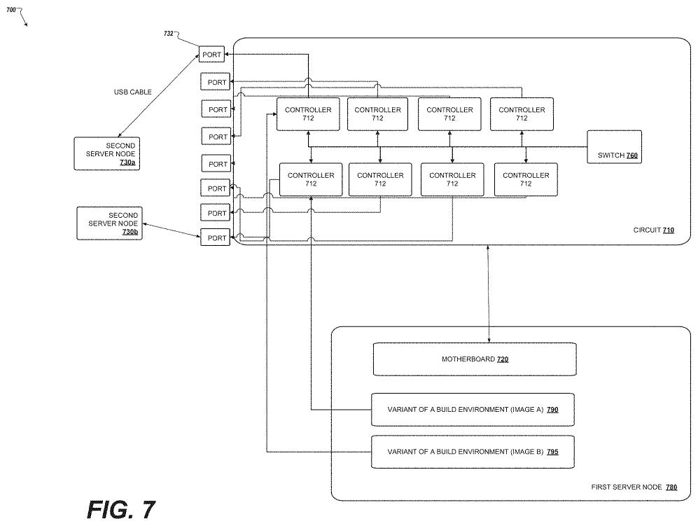

In some instances, the boot service server 510 may connect with the second server node 580 based on a USB connection (e.g., USB 550) between a connection circuit 530 and a third party controller 555 at the second server node 580. In some instances, the connection circuit 530 may connect over a USB cable connection to a connection circuit 570, where the connection circuit 530 and the connection circuit 570 are circuits that connect servers to run in a device capable mode. When the boot service server 510 is connected to the second server node 580 in the device capable mode, the boot service server 510 is presented as a mass storage device that can be accessed through the second server node 580. In some instances, the connection circuit 530 can be the circuit 710 of FIG. 7 described below. In some instances, the bootable images at repository 512 can be stored either on a local persistent storage device (for example NVMe SSD) or in non-persistent memory, e.g., a RAM Disk, having high speed and high random access rate. In some implementations, the RAM Disk contents can be populated from local persistent storage. Which one of the storages is to be used can be determined based on logic implemented at the control engine 150. For example, the decision which type of storage to use may depend on configuration rules that are set based on input and output requirements, historical data, customer tier, system requirement, etc.

In some instances, the boot service server 510 can connect with the second server node 580 based on a connection between a 3^{rd} party controller 525 at the boot service server 510 and the 3^{rd} party controller 555 at the second server node 580.

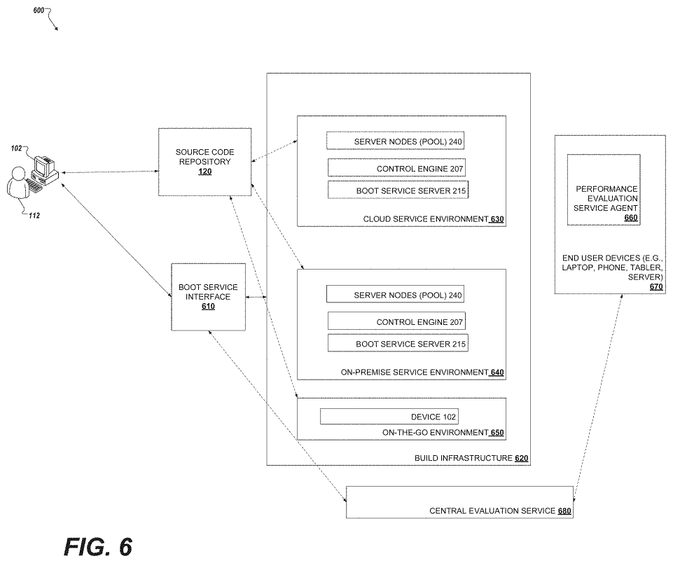

FIG. 6 is a block diagram for an example system 600 for building, testing, and distributing an application to end-user devices in accordance with implementations of the present disclosure. The example system 600 includes a build infrastructure 620 for executing build processes requested at a boot service interface 610. The boot service interface 610 may be a user interface that can be used for initiating a build process execution in relation to source code of an application, where the source code may be stored at the source code repository 120. In some instances, requests for build process execution may be received from user 602 (e.g., developer) in relation to a particular application associated with stored source code at the source code repository 120. In some instances, the user 602 may send requests for execution of build processes to the boot service interface 610, and the boot service interface 610 may initiate the build process at the build infrastructure 620 by providing a reference to the source code stored at the source code repository 120. The user may provide a network address as a reference to the location of the source code on the source code repository 120 such that the relevant source code may be downloaded for the execution of the build process. The connection with the source code repository 120 may be based on preconfigured settings at the boot service. The connection may be secure requiring the user to provide credentials for accessing the source code repository 120. In some instances, the boot service interface 610 and the build infrastructure 620 can be part of a build infrastructure landscape configured to handle execution of build and test processes on physical infrastructure, such as cloud server environment 630, on-premise service environment 640, and on-the-go environment 650.

In some instances, the build infrastructure 620 and the boot service interface 610 may be associated with a central evaluation service 680 and with performance evaluation service agents 660 that are running on end-user devices 670. The performance evaluation service agents 660 may be installed on the end-user devices 670 to collect quantitative and qualitative metrics of the performance of software applications running on the end-user devices 670, the software applications being associated with build and test processes administered through the build infrastructure 620. In some instances, the performance evaluation service agent 660 may be installed as an add-on component on each of the end-user devices 670 and can be configured to collect qualitative and quantitative metrics. In some instances, collected metrics from the performance evaluation service agents can be input to the central evaluation service 680 or directly provided to the boot service interface 610 to gather feedback and data that can used to configure actionable tasks associated with the build and test processes. In some instances, the add-on component that runs as an agent on the end-user device 670 can be provided as a software component at build time and can be distributed to the end users as part of a released software package generated after execution of a build process. The agents, such as the performance evaluation service agent 660, may collect and send quantitative and qualitative metrics about the software application as well as relevant environmental conditions. Examples of these metrics include:
CPU, Memory, I/O utilization, power consumption, etc.;
Network consumption, latency, jitter, packet loss, goodput, etc.;
Application internal metrics, crash reports, errors, traces, etc.;
QoE (Quality of Experience) metrics defined within the Application;
Optional qualitative feedback; and
Results of A/B tests per group.

In some instances, the build infrastructure 620 may include boot service nodes running a boot service server such as the boot service server 215 described with reference to FIG. 2. The build infrastructure can include a cloud service environment 630, an on-premise service environment 640, and/or an on-the-go environment 650 where servers are booted based on instantiated variants of build environments and in association with build and test processes. In some instances, the compile, build and test processes can be executed in various types of environments provided by the build infrastructure. For example, in a cloud service environment 630, at least a portion of the infrastructure associated with the technology described herein (e.g., a boot service server 215, a control engine 207, and/or a server pool 240) can be maintained over a cloud-based distributed computing environment. In an on-premise service environment 640, at least a portion of the infrastructure is maintained in an enterprise setting. In the on-the-go-environment 650, a computing device 102 such as a laptop computer can serve as a second server node, for example, to execute a build process on the go. For example, a software image can be manually installed on the computing device (e.g., a hypervisor software component and/or an orchestration component executing on the operating system of the laptop computer). In some implementations, the hypervisor software component and/or the orchestration component can represent a portion of the software suite available on a hypervisor image. When installed on the computing device, the hypervisor software component and/or an orchestration component can receive and process build tasks requested for execution at either the boot service interface 610 or the central evaluation service 680. In response to installing the software image on the computing device, the computing device can then boot build environments as described herein to execute build processes. The build artifacts from such build processes can be stored on the computing device 102 until a network connection becomes available, and uploaded to a repository upon such a connection becoming available for eventual consumption by the end user devices 670.

In some instances, portions of the resources required for implementing the technology described herein can be provided as platform-as-a-service (PaaS) offering. Various implementations of such a PaaS system are possible. In some implementations, the service provider can provide substantially all hardware and software resources for implementing the technology end-to-end, for example, as a cloud service environment 630. In some implementations, portions of the resources can be deployed at a customer location as an on-premise service environment 640. For example, a developer or a customer can provide a portion of the resources (hardware and/or software) required for executing build and test operations. Also, in some cases, a customer/developer may download resources from the PaaS service provider on a computing device 102 to execute build processes in an on-the-go environment 650.

FIG. 7 is a block diagram of an apparatus 700 that can facilitate efficient implementations of the technology described herein. In some instances, the apparatus 700 includes a circuit 710 that includes a plurality of device-mode-capable controllers 712 that are connected to a switch 760. The switch 760 in turn can be configured to connect with a motherboard 720 of a first server node 780 where boot services are provided. In some instances, a portion of the circuit 710 can provide the connection circuit 530 described with reference to FIG. 5, such that multiple second server nodes 730a, 730b etc. (730 in general) can be connected to the first server node 780 through corresponding ports 732. The second server nodes 730 can be substantially identical to the second server nodes 255, 260, 580 etc. described above with reference to FIGS. 2 and 5. The ports 732 can be physical ports (e.g., USB ports) facilitating hard-wired connections to corresponding second server nodes 730, virtual ports (e.g., a network port) facilitating a network connection to a remote second server node 730, or a combination of physical and virtual ports. In some implementations, by expanding the number of second server nodes that can be connected to a first server node and facilitating fast switching capabilities, the circuit 710 can achieve efficient implementation of the technology described herein. For example, parallel execution of a particular build/testing process can be sped up by making multiple second server nodes available for the process and relaying back the results to the first server node 780. This in turn can improve the speed/efficiency of software delivery in a CI/CD system.

In some instances, the circuit 710 includes a plurality of controllers 712 each connected to a corresponding port 732. The number of controllers (and correspondingly, the number of ports), can be configured based on design preferences and/or hardware/resource constraints such as the capability of the switch 760. In some implementations, the controllers 712 are device-mode-capable controllers i.e., controllers that present themselves as a mass storage device when a computing device is connected to the controller. In some implementations, the controllers 712 can be USB controllers that can connect the first server node 780 to a second server node 730 such that the first server node 780 appears as a mass storage device to the second server nodes 730. In some implementations, the switch 760 is a PCIe switch. The motherboard 720 of the first server node 780 can include a connection slot that can connect to the switch 760 and can provide corresponding number of channels to the number of controllers on the circuit 710 to support multiple connections between the first server node 780 and multiple second server nodes 730.

In some instances, the first server node 780 may be connected to a second server node 730 to boot a build environment from a corresponding disk image instantiated on the first server node. For example, a variant of a build environment (image A) 790 may be instantiated on the first server node 780 and a corresponding environment may be booted on the second server node 730a through the circuit 710. Similarly, a variant of a build environment (image B) 795 may be instantiated on the first server node 780 and a corresponding environment may be booted on the second server node 730b through the circuit 710. Each of the controllers 712 may be configured to support booting of server nodes from variant of build environments instantiated at the first server node 780. In some implementations, the second server node 730 can be an Apple® device, for example a Mac Pro®, Mac Mini®, or another Apple® device capable of running build and test environments.

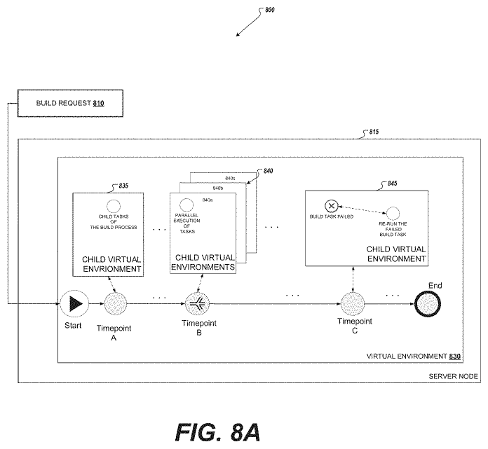

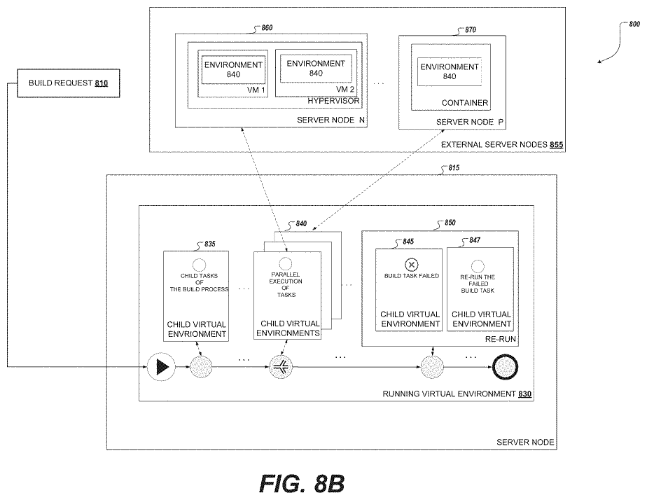

FIG. 8A is a block diagram of an example system 800 for executing a build request 810 in a virtual build environment in accordance with implementations of the present disclosure. In some instances, the example system 800 may be set up for execution of build processes on a server node 815, where the server node 815 may be one of multiple server nodes in a server pool, such as the server nodes at the server pool 240 of FIG. 2. In some instances, the end user may be a software developer who initiates the build request 810 for execution of a build process and the server node 815 may be booted to run a virtual environment 830. In some instances, the build request 810 may be initiated for execution of a build process associated with a software application defined with source code that can be stored at a source code repository. The user may request the build process for a software application associated with source code stored at a source code repository, such as the source code repository 120 of FIGS. 1 and 2.

In response to the build request 810, the server node 815 can be booted from a variant of a build environment instantiated at a boot service server such as the boot service server 215 of FIG. 2. The server node 815 can be substantially similar to the second server node 130 of FIG. 1, the server nodes 250, 255, or 260 of FIG. 2, the second server node 580 of FIG. 5, the second server node 730 and the third server node 735 of FIG. 7.

In some implementations, when the build request 810 is received, the server node 815 is scheduled to execute the build process using a build environment compatible with the build process. The server node 815 can be booted from an image of a build environment variant instantiated at the boot service server in accordance with implementations of the present disclosure. For example, the server node 815 can be booted from a bootable image to provide the virtual environment 830 as a build environment to host the requested build process. In some cases, the build process can be divided into multiple portions and may involve child tasks that can be executed in an ordered manner or in parallel based on their dependency and execution status.

In some instances, the virtual environment 830 can be provided as a virtual machine or a container running on the server node 815. Child environments can be started locally within the virtual environment 830, for example, in accordance with different child tasks of a build process. In the example of FIG. 8A, multiple child virtual environments 835, 840a-840c (840, in general), and 845, are illustrated in relation to the build request 810.

In some instances, a child virtual environment 835 may be booted to execute a portion of the build process. The child virtual environment 835 can be a virtual machine or a container environment. In some cases, a set of tasks from the build process may be executed in parallel and thus the set of tasks can be assigned to different child virtual environments 840a-840c for parallel execution.

In some instances, if a portion of a build process is executed in a child virtual environment, e.g., a build environment 845, the portion of the build process may be debugged in the event of a failure while continuing to execute other portions in corresponding build environments. For example, in case of an error event in the portion executing in the child virtual environment 845, the portion of the build executing in the virtual environment 830 can be continued, while the error is addressed (by debugging/re-run etc.) within the child virtual environment 845. In some implementations, executing different portions of a build process in corresponding child environments can also reduce the time for completion of the build process. Referring to the example of FIG. 8A, the build process executing within the virtual environment 830 is configured to be split and assigned to different child environments 835, 840, and 845 at time-points A, B, and C, respectively. In this example, if there is an error event in the portion of the build associated with the child environment 845, the portion can be addressed and re-run from time-point C, without having to execute the entire build process from the start. In some cases, this can significantly improve the efficiency of the build process and improve the process of delivering software updates in CI/CD environments.

FIG. 8B is a block diagram that illustrates additional details and implementations associated with the example system 800 of FIG. 8A. As shown in FIG. 8B, in some implementations, the multiple child environments 840 associated with parallel execution of multiple build tasks can be executed at one or more additional server nodes 855 that are external to the server node 815. For example, the child environments 840 can be booted on one or more external server nodes such as the “Server node N” 860 and “Server node P” 870. The child environments 840 can be booted either on bare metal or as virtual machines or containers running on hypervisors. For example, the “Server node N” 860 may run hypervisor build environment where two or more virtual machines can be booted to provide corresponding build environments 840. In some implementations, one or more of the build environments 840 can be booted within a container executing on a server node (Server Node P 870, in the example of FIG. 8B).

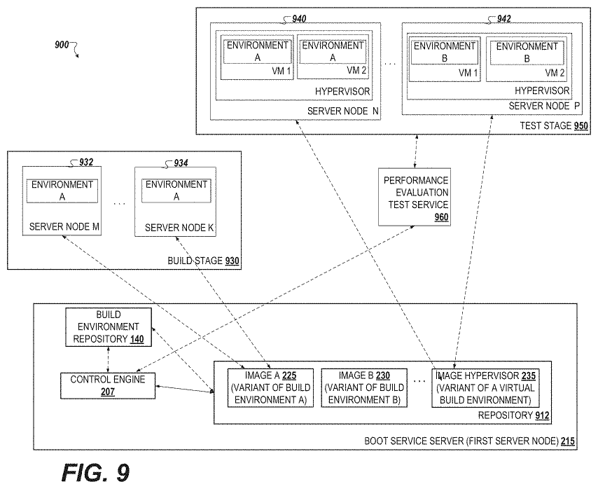

FIG. 9 is a block diagram of an example system 900 for building and testing an application in parallel on multiple server nodes in accordance with implementations of the present disclosure. In this example, the boot service server 215 facilitates the building and testing on multiple nodes 932, 934, 940, and 942 via a build stage 930 and a test stage 950. The nodes 932, 934, 940, and 942 can be selected from a server pool such as the server pool 240 described with reference to FIG. 2.

In some instances, a user (e.g., a software developer) may request an execution of a build and/or a test process via an API of a control engine 207 of FIG. 2. In some implementations, the API can be substantially identical to the API 115 described with reference to FIG. 1. In some instances, the build process and/or the test processes can be divided (also referred to as fanned out) into multiple substantially independent portions for parallel processing on multiple server nodes. In some implementations, executing the build and/or test processes in parallel over multiple server nodes can support faster delivery of software products in a CI/CD environment. In some instances, the parallel processing may be performed as parallel threads each associated with a corresponding server node. The execution of parallel processing can be configured and managed through the control engine 207. For example, the control engine 207 may manage/boot multiple server nodes depending on pre-configured rules that are stored in the back-end logic of the control engine 207. In some other instances, build and test processes may be executed over different variants of build environments. In some implementations, a build environment used for a build stage 930 may be also used for executing a test process. In some implementations, one or more separate environments may be booted, potentially on multiple server nodes exclusively for the test stage 950. The multiple environments for the building and testing processes can be booted in various ways as described in this documents. For example, while FIG. 9 shows the build stage 930 to be running on environments booted on bare metal of the corresponding nodes and the test stage to be running on environments booted on virtual machines, any combination of bare metal and virtual environments (virtual machines or containers) can be used in either stage. In some implementations, if the build stage 930 is executed in parallel threads on multiple environments, the control engine 207 can include an assembling package configured to put together the build artifacts from the various threads to generate a build package. In some instances, a testing module 960 can be provided to execute the test process and to collect test results. For example, testing module 960 can manage the test stage 950 to execute parallel test processes over multiple server nodes and collect and communicate the test results to the control engine 207.

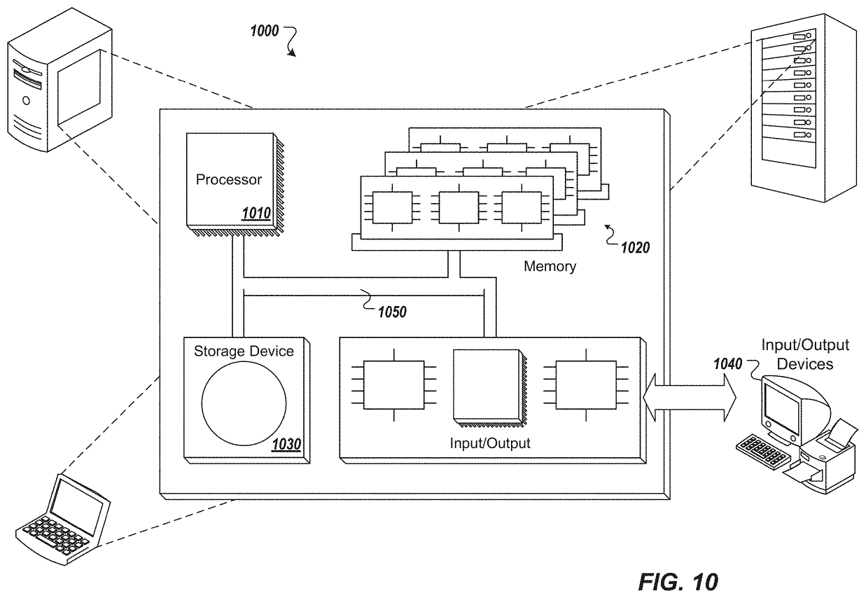

Referring now to FIG. 10, a schematic diagram of an example computing system 1000 is provided. The system 1000 can be used for the operations described in association with the implementations described herein. For example, the system 1000 may be included in any or all of the server components discussed herein. The system 1000 includes a processor 1010, a memory 1020, a storage device 1030, and an input/output device 1040. The components 1010, 1020, 1030, and 1040 are interconnected using a system bus 1050. The processor 1010 is capable of processing instructions for execution within the system 1000. In some implementations, the processor 1010 is a single-threaded processor. In some implementations, the processor 1010 is a multi-threaded processor. The processor 1010 is capable of processing instructions stored in the memory 1020 or on the storage device 1030 to display graphical information for a user interface on the input/output device 1040.

The memory 1020 stores information within the system 800. In some implementations, the memory 1020 is a computer-readable medium. In some implementations, the memory 1020 is a volatile memory unit. In some implementations, the memory 1020 is a non-volatile memory unit. The storage device 1030 is capable of providing mass storage for the system 1000. In some implementations, the storage device 1030 is a computer-readable medium. In some implementations, the storage device 1030 may be a hard disk device, an optical disk device, among other types of devices. The input/output device 1040 provides input/output operations for the system 1000. In some implementations, the input/output device 1040 includes a keyboard and/or pointing device. In some implementations, the input/output device 1040 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

1. A computer-implemented method, the method comprising:
receiving a request, at a first server node, to execute a build process on source code associated with an application, wherein the request specifies a build environment associated with executing the build process on the source code;
in response to receiving the request to execute the build process, instantiating, at the first server node, a variant of the build environment for building the source code, wherein the variant of the build environment is a bootable image that includes an operating system and software resources for starting the operating system and executing the build process on the source code; and
providing, from the first server node, instructions to boot a second server node from the bootable image, wherein the second sever node includes hardware resources for executing the build process on the source code using the variant of the build environment.

2. The method of claim 1, wherein the request is received through an application programming interface (API) at the first server node.

3. The method of claim 1, wherein the request is managed and scheduled using a control engine included in the first server node.

4. The method of claim 1, wherein the variant of the build environment is instantiated from one of a plurality of build environments stored in a repository associated with the first server node.

5. The method of claim 1, wherein the first server node includes an application programming interface for receiving and processing requests in relation to execution of build processes over hardware resources provided by server nodes using instantiated variants of build environments at the first server node.

6. The method of claim 1, wherein the second server node comprises one of: a mobile device or a portable computing device.

7. The method of claim 1, wherein providing the instructions to boot the second server node comprises initiating a virtual environment configured to execute multiple build processes in parallel.

8. The method of claim 7, wherein the virtual environment comprises a hypervisor that supports a virtual machine for executing the build process corresponding to the source code.

9. The method of claim 7, wherein the virtual environment is configured to execute multiple build processes on the second server node.

10. The method of claim 1, wherein providing the instructions to boot the second server node comprise:
selecting the second server node from a pool of server nodes, wherein the second server node is compatible with the operating system and the software resources for starting the operating system and for executing the build process.

11. The method of claim 1, further comprising executing one or more tests on a result of the build process.

12. The method of claim 1, further comprising:
in response to booting the second server node from the bootable image, downloading one or more resources for executing the build process, wherein downloading the one or more resources comprises:
receiving configuration information identifying resources associated with the build process, the configuration information identifying one or more sources corresponding to the one or more resources; and
downloading the one or more resources from the corresponding sources.

13. The method of claim 1, wherein the first server node comprises a connection circuit for connecting the first server node to at least a subset of a pool of server nodes over corresponding hardwired connections.

14. The method of claim 13, wherein the hardwired connections comprise one or more universal serial bus (USB) connections.

15. The method of claim 1, wherein the first server node is connected to at least a subset of a pool of server nodes over a wired or wireless network.

16. The method of claim 1, further comprising:
determining that the build process is complete; and
in response to determining that the build process is complete, resetting the second server node such that the second server node is available to receive instructions to boot from a different variant of a build environment instantiated at the first server node.

17. The method of claim 16, wherein resetting the second server node comprises deleting one or more software resources generated at the second server node during execution of the build process.

18. The method of claim 1, further comprising:
distributing the application to end-user devices; and
collecting, from the end-user devices, quantitative and qualitative metrics associated with performance of the application.

19. The method of claim 18, wherein distributing the application to the end-user devices comprises storing the application in a repository accessible to the end-user devices.

20. A system comprising:
a computing device; and
a computer-readable storage device coupled to the computing device and having instructions stored thereon which, when executed by the computing device, cause the computing device to perform operations comprising:
receiving a request, at a first server node, to execute a build process on source code associated with an application, wherein the request specifies a build environment associated with executing the build process on the source code;
in response to receiving the request to execute the build process, instantiating, at the first server node, a variant of the build environment for building the source code, wherein the variant of the build environment is a bootable image that includes an operating system and software resources for starting the operating system and executing the build process on the source code; and
providing, from the first server node, instructions to boot a second server node from the bootable image, wherein the second sever node includes hardware resources for executing the build process on the source code using the variant of the build environment.

21. A non-transitory, computer-readable medium coupled to one or more processors and having instructions stored thereon which, when executed by the one or more processors, cause the one or more processors to perform operations comprising:
receiving a request, at a first server node, to execute a build process on source code associated with an application, wherein the request specifies a build environment associated with executing the build process on the source code;
in response to receiving the request to execute the build process, instantiating, at the first server node, a variant of the build environment for building the source code, wherein the variant of the build environment is a bootable image that includes an operating system and software resources for starting the operating system and executing the build process on the source code; and
providing, from the first server node, instructions to boot a second server node from the bootable image, wherein the second sever node includes hardware resources for executing the build process on the source code using the variant of the build environment.

22.-37. (canceled)
